(19) United States
(12) Patent Application Publication
(10) Pub. No.: US 2013/0189511 A1
(43) Pub. Date: Jul. 25, 2013

(54) High Strength Multilayered Articles

(71) Applicant: INTERFACIAL SOLUTIONS IP, LLC, River Falls, WI (US)

(72) Inventors: Jeffrey Jacob Cernohous, Hudson, WI (US); Brandon J. Cernohous, Hudson, WI (US)

(73) Assignee: INTERFACIAL SOLUTIONS IP, LLC, River Falls, WI (US)

(21) Appl. No.: 13/749,069

(22) Filed: Jan. 24, 2013

Related U.S. Application Data
(60) Provisional application No. 61/590,146, filed on Jan. 24, 2012.

(51) Int. Cl. B32B 5/18

(52) U.S. Cl. CPC B32B 5/18
USPC 428/314.4; 156/60; 428/317.9; 428/317.1

(57) ABSTRACT

A high strength multilayered article is formed by bonding a composite layer to a foamed thermoplastic layer. At least one layer of the multilayered article possesses superior mechanical properties by admixing a polymeric matrix with naturally occurring inorganic materials in combination with an optional desiccant.

### TECHNICAL FIELD

Compositions and methods for producing composite laminates possessing superior physical characteristics.

### BACKGROUND

Volcanic ash possesses unique material properties attributed to its relatively high surface area, aspect ratio and hardness. Volcanic ash has been applied in various applications such as abrasives and as filtration aids. Additionally, the application of conventional fillers in polymeric composites has not always resulted in properties that one of ordinary skill in the art would consider superior.

### SUMMARY

The multilayered articles and methods disclosed herein produce polymeric structures having desirable mechanical characteristics. Specifically, at least one layer of the multilayered article possesses superior mechanical properties by combining a polymeric matrix with naturally occurring inorganic materials in combination with an optional desiccant. In one embodiment, polymeric composites produced using volcanic ash as the naturally occurring inorganic material and a desiccant have markedly improved physical properties (e.g., flexural modulus) when compared to polymeric materials filled with just volcanic ash or other mineral fillers. The multilayered articles have utility in many applications. Non-limiting examples include building materials and automotive components.

In one embodiment, a thermoplastic matrix is melt processed with a naturally-occurring inorganic material and a desiccant to form a useful article. In another embodiment, the thermoplastic matrix is melt processed with a naturally-occurring inorganic material, a desiccant and at least one additional filler to produce a composite. Conventional melt processing techniques may be employed to generate the polymeric composition. The thermoplastic matrix is utilized as at least one layer of a multilayered article. The thermoplastic matrix can be bonded to a layer of foamed thermoplastic material for producing the multilayered article. The foamed thermoplastic enables the production of a light weight article with dimensions very desirable for certain applications.

The following terms used in this application are defined as follows:

“Cellulosic Filler” means natural or man-made materials derived from cellulose. Cellulosic materials include, for example: wood flour, wood fibers, sawdust, wood shavings, newsprint, paper, flax, hemp, grain hulls, kenaf, jute, sisal, nut shells or combinations thereof.

“Composite” means a mixture of a polymeric material and a filler.

“Desiccant” means a material that either induces or sustains a state of dryness.

“Filler” Means an organic or inorganic material that does not possess viscoelastic characteristics under the conditions utilized to melt process the filled polymeric matrix.

“Melt Processable Composition” means a formulation that is melt processed, typically at elevated temperatures, by means of a conventional polymer processing technique such as, for example, extrusion or injection molding.

“Naturally Occurring Inorganic Material” means an inorganic material that is found in nature, for example, volcanic ash.

“Polymeric Matrix” means a melt processable polymeric material or resin.

The above summary is not intended to describe each disclosed embodiment or every implementation. The detailed description that follows more particularly exemplifies illustrative embodiments.

### DESCRIPTION OF THE DRAWINGS

FIG. 1 is a segmented view of a multilayered article.

### DETAILED DESCRIPTION

The compositions and methods disclosed herein are suitable for producing high strength multilayered articles. The multilayer articles include at least one composite layer bonded to a foamed thermoplastic layer. Specifically, at least one composite layer of the article, resulting from the admixture of polymeric matrix, naturally occurring inorganic materials, and a desiccant, possesses superior mechanical properties. In one embodiment, a polymeric matrix is melt processed with a desiccant and volcanic ash as the naturally occurring inorganic material to form the composite layer. Surprisingly, polymer composites produced using a mixture of a polymeric matrix, desiccant and volcanic ash have markedly improved flexural properties when compared to thermoplastic materials filled with conventional inorganic fillers. Specifically, composites having a flexural modulus of greater than 2500 MPa are described. The composite layer also has improved thermal properties. For example, the coefficients of thermal expansion observed in certain embodiments of the composites are significantly less than polymers filled with conventional inorganic fillers. Composite layers having a coefficient of thermal expansion of less that 70 μm/m are described. The multilayered article has utility in many applications. Non-limiting examples include building materials, transportation materials and automotive components. Preferred examples included concrete forms, railroad ties and automotive sheet stock.

Any naturally occurring inorganic material is suitable in the polymeric composite layer. Some embodiments incorporate volcanic ash (individually or in combined forms of expanded, unexpanded, or micronized expanded), mica, fly ash, andesiteic rock, feldspars, aluminosilicate clays, obsidian, diatomaceous earth, silica, silica fume, bauxite, geopolymers pumice, perlite, pumicsite and combinations thereof. The various forms of volcanic ash are well suited for many end use applications. In one embodiment, the naturally occurring inorganic material is chosen such that it has an aspect ratio of at least 1.5:1 (length:width), at least 3:1, or at least 5:1. In some embodiments, the inorganic material comprises 5-60 wt % of the composition, 2060 wt %, or 30-60 wt %.

The polymeric matrix functions as the host polymer and is a primary component of the composite composition or layer. A wide variety of polymers conventionally recognized in the art as suitable for melt processing are useful as the polymeric matrix. They include both hydrocarbon and non-hydrocarbon polymers. Examples of useful polymeric matrices include, but are not limited to, polyamides, polyimides, polyurethanes, polyolefins, polystyrenes, polyesters, polycarbonates, polyketones, polyureas, polyvinyl resins, polyacrylates and polymethylacrylates. Polyolefins are well suited for many applications.

In certain embodiments, polymers suitable as the polymeric matrix in the composite layer include high density polyethylene (HDPE), low density polyethylene (LDPE), linear low density polyethylene (LLDPE), polypropylene (PP), polyolefin copolymers (e.g., ethylene-butene, ethylene-octene, ethylene vinyl alcohol), polystyrene, polystyrene copolymers (e.g., high impact polystyrene, acrylonitrile butadiene styrene copolymer), polyacrylates, polymethacrylates, polyesters, polyvinylchloride (PVC), fluoropolymers, polyamides, polyether imides, polyphenylene sulfides, polysulfones, polyacetals, polycarbonates, polyphenylene oxides, polyurethanes, thermoplastic elastomers (e.g., SIS, SEBS, SBS), epoxies, alkyds, melamines, phenolics, ureas, vinyl esters, liquid crystal polymers or combinations thereof Polyolefins and thermoplastic elastomers are well suited for certain embodiments.

The function of the optional desiccant in the composite layer is to address the moisture of the components during processing. By addressing the moisture or water present in the other components, the desiccant may significantly reduce or eliminate moisture causing defects that result in reduced physical properties. The desiccant may be any conventional material capable of moisture uptake and suitable for application in melt processed polymeric matrices. In one embodiment, the desiccant is selected from calcium oxide, magnesium oxide, strontium oxide, barium oxide, aluminum oxide, or combinations thereof. Those of ordinary skill in the art of melt processing polymers are capable of selecting a specific desiccant in combination with a polymer matrix, filler, and other optional components or additives to achieve the beneficial results. The amount of desiccant will vary, but may include a range of about 1 to 20 wt % of the formulation in the composite formulation.

In another aspect, the modified polymer matrix of the composite layer can be melt processed with additional fillers. Non-limiting examples of fillers include mineral and organic fillers (e.g., talc, mica, clay, silica, alumina, carbon fiber, carbon black glass fiber) and conventional cellulosic materials (e.g., wood flour, wood fibers, sawdust, wood shavings, newsprint, paper, flax, hemp, wheat straw, rice hulls, kenaf, jute, sisal, peanut shells, soy hulls, or any cellulose containing material). The amount of filler in the composite layer may vary depending upon the polymeric matrix and the desired physical properties of the finished composition. Those skilled in the art of melt processing polymers are capable of selecting appropriate amounts and types of fillers to match with a specific polymeric matrix in order to achieve desired physical properties of the finished material.

The amount of the filler in the composite layer may vary depending upon the polymeric matrix and the desired physical properties of the finished composition. Those skilled in the art of melt processing polymers are capable of selecting an appropriate amount and type of filler(s) to match with a specific polymeric matrix in order to achieve desired physical properties of the composite layer. Typically, the filler may be incorporated into the melt processable composition in amounts up to about 90% by weight. Preferably, the filler is added to the melt processable composite composition at levels between 5 and 90%, more preferably between 15 and 80% and most preferably between 25 and 70% by weight of the formulation. Additionally, the filler may be provided in various forms depending on the specific polymeric matrices and end use applications such as, for example, powder and pellets.

In certain embodiments, cellulosic materials are commonly utilized in melt processable compositions as fillers to impart specific physical characteristics or to reduce the cost of the composite layer. Cellulosic materials generally include natural or wood based materials having various aspect ratios, chemical composition, densities, and physical characteristics. Non-limiting examples of cellulosic materials include wood flour, wood fibers, sawdust, wood shavings, newsprint, paper, flax, hemp, rice hulls, kenaf, jute, sisal, and peanut shells. Combinations of cellulosic materials and a modified polymer matrix may also be used in the melt processable composition. In a preferred embodiment, the cellulosic filler comprises 5-60 wt % of the composition, 5-40 wt %, or 5-20 wt %.

In another aspect, the melt processable composite layer may include coupling agents to improve the compatibility and interfacial adhesion between the thermoplastic matrix and the naturally-occurring inorganic material and any other fillers. Non-limiting examples of coupling agents include functionalized polymers, organosilanes, organotitanates and organozirconates. Preferred functionalized polymers include functionalized polyolefins, polyethylene-co-vinyl acetate, polyethylene-co-acrylic acid, and polyethylene-co-acrylic acid salts.

In yet another embodiment, the composite layer composition may contain other additives. Non-limiting examples of conventional additives include antioxidants, light stabilizers, fibers, blowing agents, foaming additives, antiblocking agents, heat stabilizers, impact modifiers, biocides, compatibilizers, flame retardants, plasticizers, tackifiers, colorants, processing aids, lubricants, coupling agents, and pigments. The additives may be incorporated into the melt processable composition in the form of powders, pellets, granules, or in any other extrudable form. The amount and type of conventional additives in the composite layer may vary depending upon the polymeric matrix and the desired physical properties of the finished composition. Those skilled in the art of melt processing are capable of selecting appropriate amounts and types of additives to match with a specific polymeric matrix in order to achieve desired physical properties of the finished material.

The composite layer can be prepared by any of a variety of ways. For example, the modified polymeric matrix, desiccant, and naturally occurring inorganic material may be combined together by any of the blending means usually employed in the plastics industry, such as with a compounding mill, a Banbury mixer, or a conventional mixer. The materials may be used in various forms, for example, a powder, a pellet, or a granular product. The mixing operation is most conveniently carried out at a temperature above the melting point or softening point of the processing additive, though it is also feasible to dry-blend the components in the solid state as particulates and then cause uniform distribution of the components by feeding the dry blend to a twin-screw melt extruder. The resulting melt-blended mixture can be either extruded directly into the form of the final product shape or pelletized or otherwise comminuted into a desired particulate size or size distribution and fed to an extruder, which typically will be a single-screw extruder, that melt-processes the blended mixture to form the final product shape.

Melt-processing typically is performed at a temperature from 120° C. to 300° C., although optimum operating temperatures are selected depending upon the melting point, melt viscosity, and thermal stability of the composition. Different types of melt processing equipment, such as extruders, may be used to process the composite layer. Melt processing may also include injection molding, batch mixing, blow molding or rotomolding.

The high strength, multilayered article is formed by bonding a composite layer to a foamed thermoplastic layer. In another embodiment, a second composite layer is bonded to the foamed thermoplastic layer on a side of the foamed thermoplastic layer opposite the first composite layer to make a sandwich structure. The composite layers and the foamed thermoplastic layer are adhered using adhesive bonding techniques to produce the composite laminate structure. In one embodiment, the composite laminate has a specific gravity of less than 1.0 g/cm³, in another embodiment the composite laminate has a specific gravity of less than 0.8 g/cm³. In one embodiment, the flexural modulus of the composite laminate is greater than 2000 MPa. In another embodiment the composite laminate has a flexural modulus greater than 3000 MPa.

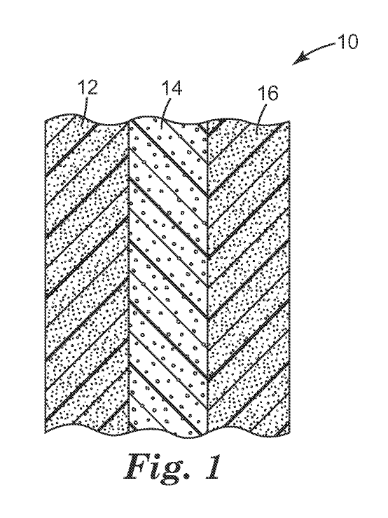

FIG. 1 depicts one embodiment of the multilayered article 10 having a first composite layer 12 bonded to a foamed thermoplastic layer 14. An optional second composite layer 16 is bonded to the opposite side of the foamed thermoplastic layer 14.

The foamed thermoplastic layer may be comprised of any thermoplastic polymer. Non-limiting examples of useful foamed thermoplastic polymers include: polyolefins (e.g., polyethylene and polypropylene), polyvinylchloride, polyamides, polyesters, polystyrene, polyacrylates, and polyurethanes. In one embodiment, the foamed thermoplastic polymer is a polyamide. The foamed thermoplastic layer is characterized by having lightweight characteristics. In one embodiment, the foamed thermoplastic layer has a specific gravity less than 0.5 g/cm³. In another embodiment, the foamed thermoplastic layer has a specific gravity less than 0.3 g/cm³. In yet another embodiment, the foamed thermoplastic polymer has a closed cell morphology. Conventional foaming techniques, such as supercritical gas injection or the use of chemical blowing agents, are well suited for creating the foamed thermoplastic layer.

The composite layers are adhered to the foamed thermoplastic layer using adhesive bonding techniques. In one embodiment, the layers are thermally or ultrasonically welded together to promote adequate adhesion. In another embodiment, the layers are adhered together using a pressure sensitive adhesive. In another embodiment, the layers are adhered together using a hot melt adhesive. In certain embodiments, the layers are adhered using a structural adhesive. Useful adhesives are those that have the capability to bond the composite layer to the foamed thermoplastic. In one embodiment, the adhesive is capable of adequately bonding a low surface energy composite and low surface energy thermoplastic foam. In another embodiment, the adhesive is capable of adequately bonding a low surface energy composite to a high surface energy thermoplastic foam. In one embodiment, a useful structural adhesive for producing this laminate is 3M Scotch Weld DP-8005.

The high strength multilayered articles are suitable for various industries, including the construction and automotive industries. For example, in the construction industry, articles incorporating the multilayered article may include: concrete forms, decking, sheeting, structural element, roofing tiles, and siding. The improved mechanical properties of the multilayered article enable thin and or hollow profiles, thereby reducing cost and weight for particular end use application. Those of ordinary skill in the art of designing construction articles are capable of selecting specific profiles for desired end use applications. Applications in the automotive industry include: body and interior panels and decorative articles. The composites have particular utility for producing sheet articles that are utilized as concrete forms. Additionally, railroad ties may be formed using the composites.

The resulting multilayered articles exhibit superior mechanical characteristics in the field of composite structures. In one embodiment, the flexural modulus is as much as 30% higher over conventional composite materials. Certain embodiments exhibit a flexural modulus of greater than 2500 MPa and a coefficient of thermal expansion of less than 70 μm/m. Additionally, the composite may exhibit a ratio of flexural modulus to specific gravity of greater than 2100:1.

MATERIALS

| MATERIAL | DESCRIPTION |
|---|---|
| PP | H12Z-00, 12 MFI polypropylene homopolymer commer- |
| | cially supplied by Ineos, Inc. (League City, TX) |
| Volcanic | Dry volcanic ore, commercially available from Kansas |
| Ash | Minerals, Inc. (Mankato, KS) |
| Desiccant | Polycal OFT15 calcium oxide, commercially available |
| | from Mississippi Lime (St Louis, MO) |
| Coupling | Polybond 3000, maleic anhydride grafted polypropylene, |
| Agent | commercially available from Chemtura Inc |
| | (Middlebury, CT) |
| Adhesive | 3M Scotch Weld DP8005, commercially available from |
| | 3M Co. (St. Paul, MN) |
| Thermo- | Foamed nylon sheet, 6 mm thickness, commercially |
| plastic | available from McMaster-Carr (Elmhurst, IL) |
| Foam | |

PREPARATION OF EXAMPLE 1.

Composite sheet samples were prepared and tested using the following protocol. PP coupling agents were separately gravimetrically fed in to an extruder feed throat. Volcanic Ash and desiccant were dry blended and gravimetrically fed separately into a side stuffer. The resulting compounded using a 50 mm co-rotating twin screw extruder fitted with ten strand die (commercially available from American Leistritz Extruder Corporation, Sommerville, N.J.). All samples were processed at 300 rpm screw speed using the following temperature profile: Zone 1-2=170° C., Zone 3-4=180° C., Zone 5-6=190° C., Zone 7-8=190 ° C. The resulting strands were subsequently cooled in a water bath and pelletized into ˜6 mm pellets to produce the composite formulation. The resulting pellets were continuously compression molded into a sheet having a thickness of 5.0 mm and a width of 1200 mm using a double belt press commercially available from Technopartners Samtronic (Mulhausen, Germany). The samples were processed at 180° C. for all heating zones and 70° C. for the cooling zones. The line speed was 1.0 m/min. The resulting sheet samples were machined into 300 mm×300 mm test specimens. Example 1 was prepared in the following manner. Two test specimens of CE1 were coated with the adhesive on one side and laminated to the thermoplastic foam. The laminate structure was clamped and allowed to cure at room temperature for 24 hours to make the composite laminate. The sample was tested for Specific Gravity for the composite laminate was determined using Archimedes principle, flexural properties following ASTM D790 and linear coefficient of thermal expansion following ASTM 696-08. The formulation produced is given in Table 2 and the characterization results are given in Table 3.

TABLE 2
EXPERIMENTAL FORMULATION OF
COMPARATIVE EXAMPLE CE1

| | | Volcanic | | Coupling |
|---|---|---|---|---|
| Sample | Polypropylene | Ash | Desiccant | Agent |
| CE1 | 38 | 55 | 5 | 2 |

TABLE 3
PROPERTIES OF COMPARATIVE
EXAMPLE CE1 AND EXAMPLE 1

| | Flexural | Flexural | | Specific |
|---|---|---|---|---|
| | Modulus | Strength | Linear CTE | Gravity |
| Sample | (MPa) | (MPa) | (μ/m° C. × 10⁻⁶) | (g/cm³) |
| CE1 | 5170 | 57 | 15 | 1.25 |
| 1 | 2550 | 55 | 15 | 0.67 |

What is claimed is:

1. A multilayered article comprising a first composite layer bonded to a foamed thermoplastic layer, wherein the first composite layer is derived from a polymeric matrix including a naturally-occurring inorganic material, and optionally a desiccant.

2. A multilayered article according to claim 1, further comprising a second composite layer bonded to an opposing side of the foamed thermoplastic layer from the first composite layer.

3. A multilayered article according to claim 1, wherein the naturally-occurring inorganic material is volcanic ash, mica, fly ash, andesiteic rock, feldspars, aluminosilicate clays, obsidian, diatomaceous earth, silica, silica fume, bauxite, geopolymers pumice, perlite, pumicsite or combinations thereof.

4. A multilayered article according to claim 1, wherein the naturally-occurring inorganic material is volcanic ash.

5. A multilayered article according to claim 1, wherein the polymeric matrix is high density polyethylene, low density polyethylene, linear low density polyethylene, polypropylene, polyolefin copolymers, polystyrene, polystyrene copolymers, polyacrylates, polymethacrylates, polyesters, polyvinylchloride, fluoropolymers, liquid crystal polymers, polyamides, polyether imides, polyphenylene sulfides, polysulfones, polyacetals, polycarbonates, polyphenylene oxides, polyurethanes, thermoplastic elastomers, epoxies, alkyds, melamines, phenolics, ureas, vinyl esters, liquid crystal polymers or combinations thereof.

6. A multilayered article according to claim 1, wherein the desiccant is calcium oxide, magnesium oxide, strontium oxide, barium oxide, aluminum oxide, or combinations thereof.

7. A multilayered article according to claim 1, wherein the first composite layer includes a coupling agent.

8. A multilayered article according to claim 2, wherein the first or second composite layer has a specific gravity of less than 1.0 g/cm³.

9. A multilayered article according to claim 1, wherein the multilayered article has a flexural modulus greater than 2000 MPa.

10. A multilayered article according to claim 1, wherein the foamed thermoplastic layer is a polyolefin, polyvinylchloride, polyamide, polyester, polystyrene, polyacrylate, polyurethane, or a combination thereof

11. A multilayered article according to claim 1, wherein the foamed thermoplastic layer has a specific gravity less than 0.5 g/cm³.

12. A multilayered article according to claim 1, wherein the foamed thermoplastic layer has a closed cell morphology.

13. A multilayered article according to claim 1, further comprising an adhesive interposed between the first composite layer and the foamed thermoplastic layer.

14. A multilayered article according to claim 1, wherein the first composite layer and the foamed thermoplastic layer are thermally bonded together or ultrasonically welded together.

15. A multilayered article according to claim 1, wherein the multilayered article exhibits a ratio of flexural modulus to specific gravity of greater than 2100:1.

16. A multilayered article comprising a first composite layer bonded to a foamed thermoplastic layer, and second composite layer bonded to an opposing side of the foamed thermoplastic layer from the first composite layer, wherein the first composite layer and the second composite layer are derived from melt processable a polymer, volcanic ash and optionally a desiccant.

17. A method comprising forming a multilayered article by bonding a first composite layer to a foamed thermoplastic layer, wherein the first composite layer is a polymeric compound derived from a polymeric matrix, naturally-occurring inorganic material, and optionally a desiccant.
